(19) United States
(12) Patent Application Publication
(10) Pub. No.: US 2017/0010885 A1
(43) Pub. Date: Jan. 12, 2017

(54) Wireless Data Update System and Method

(71) Applicants: Yi-Che Chen, Toufen Township (TW); Chia-Hao Teng, Toufen Township (TW); Tien-Der Yeh, Toufen Township (TW)

(72) Inventors: Yi-Che Chen, Toufen Township (TW); Chia-Hao Teng, Toufen Township (TW); Tien-Der Yeh, Toufen Township (TW)

(21) Appl. No.: 14/792,643

(22) Filed: Jul. 7, 2015

(51) Int. Cl. G06F 9/445; H04W 12/06; H04W 12/10; H04W 76/02; H04L 12/24

(52) U.S. Cl. CPC G06F 8/67; H04W 76/023; H04L 41/082; H04W 12/10; H04W 12/06; G06F 8/665

(57) ABSTRACT

A method for facilitating a data update is performed. The method includes by a source communication apparatus initiating the data update, establishing a communication link with a target communication apparatus by periodically polling, and transmitting encrypted update data to the target communication apparatus through the interface module. The method further includes by the target communication apparatus after the encrypted update data is completely received operating by executing a first set of instructions in the first storage space and when the data update concludes operating by executing a second set of instructions in the second storage space.

### BACKGROUND

1. Technical Field

The present disclosure relates to wireless data update, and, more particularly, to a system and method capable of facilitating the wireless update.

2. Description of Related Art

As electronic devices have been an integral part of people's daily life, how to make the use of them more convenient is critical for them to gain additional popularity. The electronic devices more or less could be employing outdated firmware and/or software, limiting their applicability or even rendering them incompatible in certain more advanced environments. Thus, automatic or self-initiated update/refresh to firmware and/or software of the electronic devices could help minimize the occurrence of the above undesired situation.

Traditionally, for any update to firmware often running on a system on chip (SOC) of the electronic device to proceed, a specialized tool for the SOC or connection of the electronic device to an update source through a universal serial bus (USB) port is necessary, which may cause inconvenience especially when the specialized tool or an USB cord may be unavailable on some occasions.

### SUMMARY

The present disclosure provides a system capable of wirelessly facilitating data update. The system may include a first communication apparatus defining a first storage space and a second storage space, and a second communication apparatus having a control module and an interface module. The control module is configured to: initiate the data update for the first communication apparatus, establish a communication link with the first communication apparatus through the interface module after identifying the first communication apparatus with either first configurable identity information or second configurable identity information by periodically polling, and transmit encrypted update data to the first communication apparatus with either the first configurable identity information or the second configurable identity information through the interface module. After the encrypted update data is completely received by the first communication apparatus, the first communication apparatus is configured to operate by executing a first set of instructions in the first storage space and when the corresponding data update concludes the first communication apparatus is configured to operate by executing a second set of instructions in the second storage space.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a simplified block diagram of a system capable of facilitating a wireless data update according to one embodiment of the present disclosure;

FIG. 2 shows a flow chart of a method performed at the second communication apparatus for facilitating the wireless data, update according to one embodiment of the present disclosure;

FIG. 3 shows a flow chart of a method performed at the first communication apparatus for facilitating the wireless data update according to one embodiment of the present disclosure; and

FIG. 4 shows a schematic diagram illustrating a non-transitory computer readable media product according to one embodiment of the present disclosure.

### DESCRIPTION OF THE EXEMPLARY EMBODIMENTS

The aforementioned and other technical contents, features, and efficacies will be shown in the following detail descriptions of at least one embodiment corresponding with the reference figures.

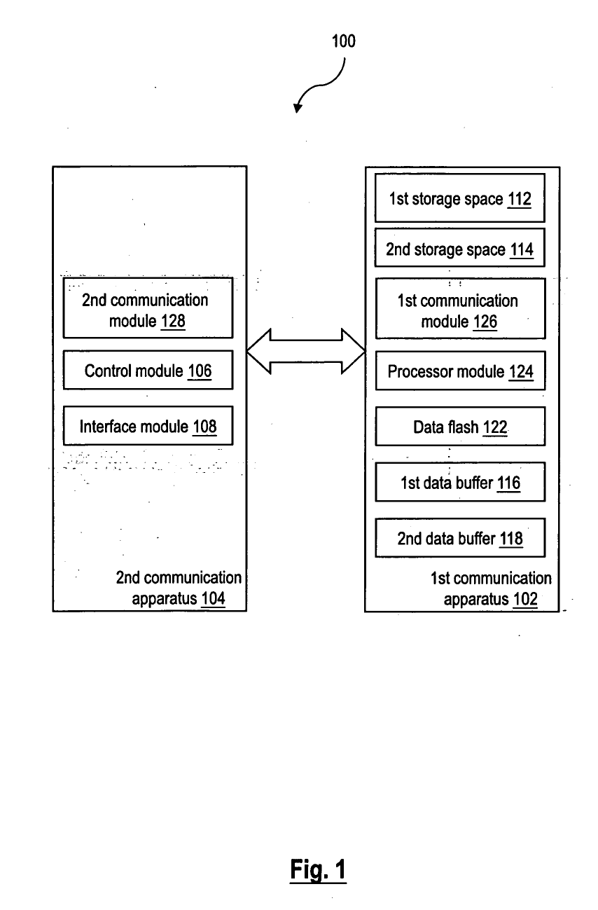

Please refer to FIG. 1 of a simplified block diagram showing a system 100 capable of facilitating a wireless data update according to one embodiment of the present disclosure. The system 100 may include a first communication apparatus 102 and a second communication apparatus 104. The first communication apparatus 102 may be the apparatus to be updated using update data from the second communication apparatus 104. The second communication apparatus 104 may include a control module 106 and an interface module 108. The control module 106 may be responsible for operations of the second communication apparatus 104. The interface module 108 may be used for the transmission of the update data to the first communication apparatus 102 and the receipt of data from the first communication apparatus 102. In one implementation, the control module 106 may be a central processing unit while the interface module 108 may be one commercially available interface such as Wi-Fi or 4-G interface.

In one implementation, the first communication apparatus 102 may be a remote control, whose firmware from time to time may require to be updated. In one implementation, the second communication apparatus may be implemented to have a host computer and a dongle electrically coupled to the host computer. The dongle and the host computer may be connected through any available interface, whether it is wired or wireless-based. In one implementation, the dongle may be connected to the host computer through one universal serial bus (USB) port of the host computer. The host computer may be used to download update data from a remote source and store the downloaded update data. The update data may be delivered, to the remote control through the dongle wirelessly.

There may be one data update program running on the host computer and when executed such data update program may initiate the data update. Since the host computer may store the update program, the host computer along with the dongle may be regarded as a source communication apparatus in the present disclosure. On the other hand, a communication apparatus such as the first communication apparatus set to be updated may be considered as a target communication apparatus with respect to the source communication apparatus.

The first communication apparatus 102 may have one storage unit (not shown) defining a first storage space 112 and a second storage space 114. The storage unit, in one implementation, may be a hard disk. The first communication apparatus 102 may further include a first data buffer 116, a second data buffer 118, and a data flash 122. Each of the first data buffer 116, the second data buffer 118, and the data flash 122 may be within the above-mentioned storage unit in one implementation. In another implementation, however, each or some of them may be physically separated from the storage unit.

Plus, the first communication apparatus 102 may include a processor module 124 for operations of the first communication apparatus 102 and a first communication module 126, with the second communication apparatus 104 equipped with a second communication module 128. In one implementation, the processor module 124 may be another processor unit. In one implementation, the first communication module 126 and the second communication module 128 may be any commercially available communication module which may be in form of a signal transmission circuit/chip.

The second storage space 114 may store a full set of instructions for the operations of the first communication apparatus 102 when executed by the processor module 124 and some or even entire set of those instructions (e.g., outdated firmware of the first communication apparatus 102) may require to be updated either randomly or regularly. Random wireless data update may be performed disregarding whether the first communication apparatus 102 may just have been refreshed with the latest version of the update data, or whether any latest version of the update data is available. The first storage space 112, meanwhile, may store only a subset of the instructions in the second storage space 114, for at least maintaining communication between the first communication apparatus 102 and the second communication apparatus 104 when needed. That the first storage space 112 may need to have those instructions stored and executed may be because when the wireless data update using the update data to refresh the instructions in the second storage space 114 the instructions in the first storage space 112 rather than those in the second storage space 114 may be responsible for the operations of the first communication apparatus 102. And in order for the wireless data update to be properly and successfully accomplished the instructions for the communication between the first communication apparatus 102 and the second communication apparatus 104 may be needed as well.

The update data may be transmitted by the second communication module 128, through the interface module 108, and received by the first communication module 126. The first communication module 126 may further deliver the received update data to the first data buffer 116 or the second data buffer 118. One of the two data buffers 116 and 118 may be used to receive the update data when the other may be used for the storage of the update data. And when the data buffer 116 or 118 for the storage of the update data is full such update data may be stored into the data flash 122.

It is worth noting that the update data may be further encrypted at the second communication apparatus 104 by the control module 106, which may have certain encryption algorithm incorporated. Depending on the encryption algorithm incorporated, the update data may be partially, fully, or randomly encrypted. The encrypted update data in terms of packets may be delivered to the first data buffer 116 or the second data buffer 118. And the update data at the time of being stored into the data flash 122 may remain encrypted. For the entire update data to be received by the first communication apparatus 102, on some occasions the packetized encrypted update data may need to be resent by the second communication module 128 especially when those particular packets are not successfully received at the first communication apparatus 102.

Decryption of the update data may start once after the entire update data is properly received by the first communication apparatus 102. That the decryption of the update data may be performed when the update data is fully received may minimize the likelihood of interception or compromise to integrity of the update data typically occurring over the course of wireless transmission.

Each of the packets transmitted from the second communication apparatus 104 to the first communication apparatus 102 may be formatted to include an index of the packet (e.g., the “first” packet of the encrypted data), a data size of the packet, the encrypted packet of the update data itself, a packet verification code, and a transmission state suggesting the number of the transmissions of this particular packet. It is worth noting that the above format is just one example. The format of the transmission of the packets may vary depending on the communication modules adopted (or corresponding communication protocols).

Upon the receipt of the packet, the first communication apparatus 102 may respond with a feedback. In one implementation, the feedback may be formatted to include the index of the received packet and the data size of the received packet to acknowledge the corresponding receipt may be a successful one. As with the format of the transmission of the packet from the second communication apparatus 104 to the first communication apparatus 102, the format of the feedback may vary depending on the communication protocols used.

The second communication apparatus 104 after receiving the feedback indicating the successful receipt of one encrypted packet may be configured to transmit the next encrypted packet. On the other hand, the feedback may be formatted to suggest an unsuccessful receipt allowing for the second communication apparatus 104 to re-transmit the same encrypted packet. In another implementation, when the second communication apparatus 104 fails to receive the feedback within a predetermined period of time starting from the transmission of the encrypted packet the second communication apparatus 104 may re-transmit the same packet disregarding whether any feedback is received from the first communication apparatus 102.

The dongle despite functioning as the interface module 108 may also have a data buffer (not shown) for storing the encrypted packet of the update data before the transmission of the encrypted packet to the first communication apparatus 102 may officially start. When the data buffer is full, the stored encrypted packets may be delivered to the first communication apparatus 102. In another implementation, the delivery of the stored encrypted packets may be performed over the course of the receipt of the encrypted packets. In other words, the receipt and delivery of the encrypted packets may proceed at the same time. To serve this purpose, the data buffer may be divided into a predetermined number of sub-buffers, each of whom may be in the same or different size. Once one sub-buffer is full, the encrypted packets in that particular sub-buffer may be transmitted to the first communication apparatus 102 disregarding whether another sub-buffer may have been in the process of receiving another series of the encrypted packets. And the feedback from the first communication apparatus 102 may be through the dongle (or the interface module 108) before being received by the host computer (or the control module 106).

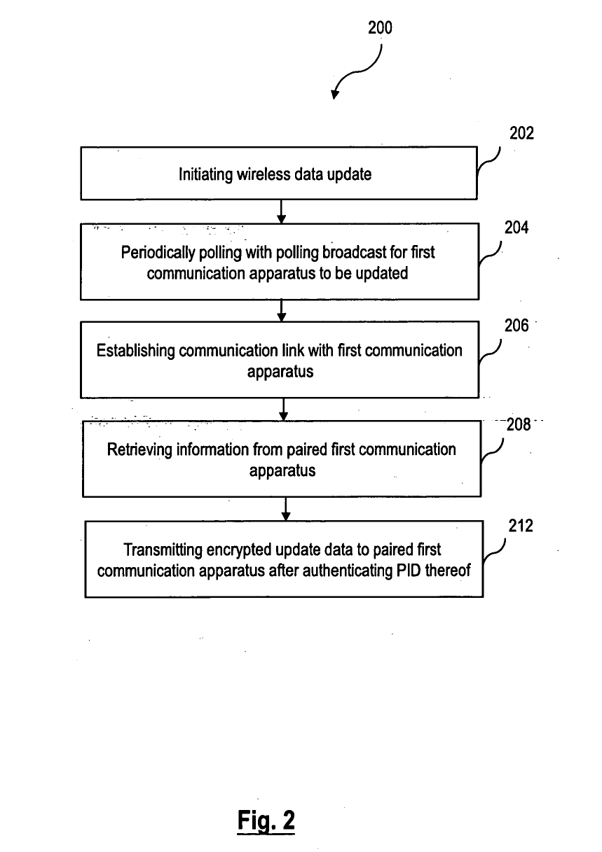

In conjunction with FIG. 1, FIG. 2 shows a flow chart of a method 200 performed at the second communication apparatus 104 for facilitating the wireless data update according to one embodiment of the present disclosure.

The method 200 may include initiating the wireless data update by the control module 106 (step 202). When the wireless data update is initiated, the second communication apparatus 104 may either begin downloading the update data from the remote source or utilize the update data already downloaded and stored therein. Also when the process of the wireless data update is initiated, the second communication apparatus 104 may start periodically polling with a polling broadcast using the second communication module 128 and the interface module 108 for any first communication apparatus 102 to be updated (step 204). In one implementation, the polling broadcast may alternate first configurable identity information with second configurable identity information. The second communication apparatus 104 may establish a communication link with the first communication apparatus having either the first configurable identity information or the second configurable identity information through the second communication module 128 (step 206).

The first configurable identity information may indicate the first communication apparatus 102 with such first configurable identity information may be paired with the second communication apparatus 104 most recently. In other words, the first communication apparatus 102 with the first configurable identity information aside, no other first communication apparatus 102 may have been establishing the communication link with the second communication apparatus 104 for the wireless update. And pairing with that particular first communication apparatus 102 may be highly prioritized by the second communication apparatus 104. Thus, in one implementation, the second communication apparatus 104 may first establish the communication link with the first communication apparatus 102 with the first configurable identity information, before establishing the communication links with other first communication apparatus 102.

The first communication apparatus 102 with the second configurable identity information may not even communicate with the second communication apparatus 104 before or may not be the one communicating with the second communication apparatus 104 most recently. To respond to the polling broadcast, in one implementation a particular button of the first communication apparatus 102 may be firstly pressed.

In step 208, once after the communication link between the first communication apparatus 102 and the second communication apparatus 104 is established, the second communication apparatus 104 may retrieve information from the first communication apparatus 102. The information retrieved by the second communication apparatus 104 may include version number of the firmware to be updated at the first communication apparatus 102 along with personal identity code (PID) of the first communication apparatus 102. Once the PID of the first communication apparatus 102 has been verified or authenticated by the second communication apparatus 104, the second communication apparatus 104 may begin transmitting the encrypted update data (step 212).

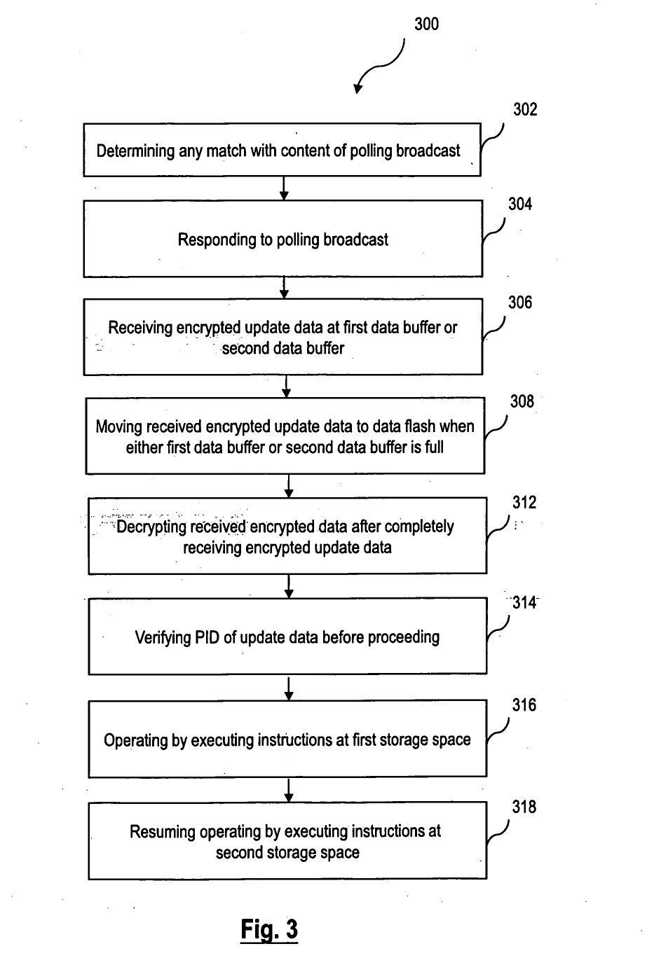

In conjunction with FIG. 1, FIG. 3 is a method 300 performed by the first communication apparatus 102 for facilitating the wireless data update according to one embodiment of the present disclosure.

The method 300 may include in step 302, upon the receipt of the polling broadcast, determining whether identity information in the first communication apparatus 102 matches either the first configurable identity information or the second configurable identity information. If so, the first communication apparatus 102 may respond to the polling broadcast indicating its possession of either the first configurable identity information or the second configurable identity information (step 304).

Once after the communication link with the second communication apparatus 104 is established, and the personal identity code of the first communication apparatus 102 is authenticated, the first communication apparatus 102 may begin receiving the encrypted packets of the update data at either the first data buffer 116 or the second data buffer 118 (step 306).

When one of the first data buffer 116 or the second data buffer 118 is full at which point the other may still be receiving the packets of the update data, the first communication apparatus 102 may move the received encrypted packets of the update data at the fully occupied data buffer (whether it is the first data buffer 116 or the second data buffer 118) to the data flash 122 (step 308).

When the encrypted update data is completely received, the corresponding decryption may be performed by the processor module 124 of the first communication apparatus 102, which may be incorporated with decryption mechanism/algorithm (step 312). With the decryption, a personal identity code (PID) of the update data may be verified by the processor module 124 before any update/refresh to the instructions (or the firmware) in the second storage space 114 could be proceeded (step 314).

When the PID of the update data is verified or authenticated, the processor module 124 may be configured to execute the instructions first storage space 112 (step 316). In other words, at the time of the update/refresh to the instructions of the second storage space 114 is to be performed the first communication apparatus 102 may suspend the execution of the instructions at the second storage space 108. Instead, the processor module 124 may turn to the instructions of the first storage space 112 allowing for the first communication apparatus 102 to maintain its routine operations with them. And when the data update to the instructions at the second storage space 114 concludes the processor module 124 may resume the execution of the instructions (or the update ones) at the second storage space 114 (step 318).

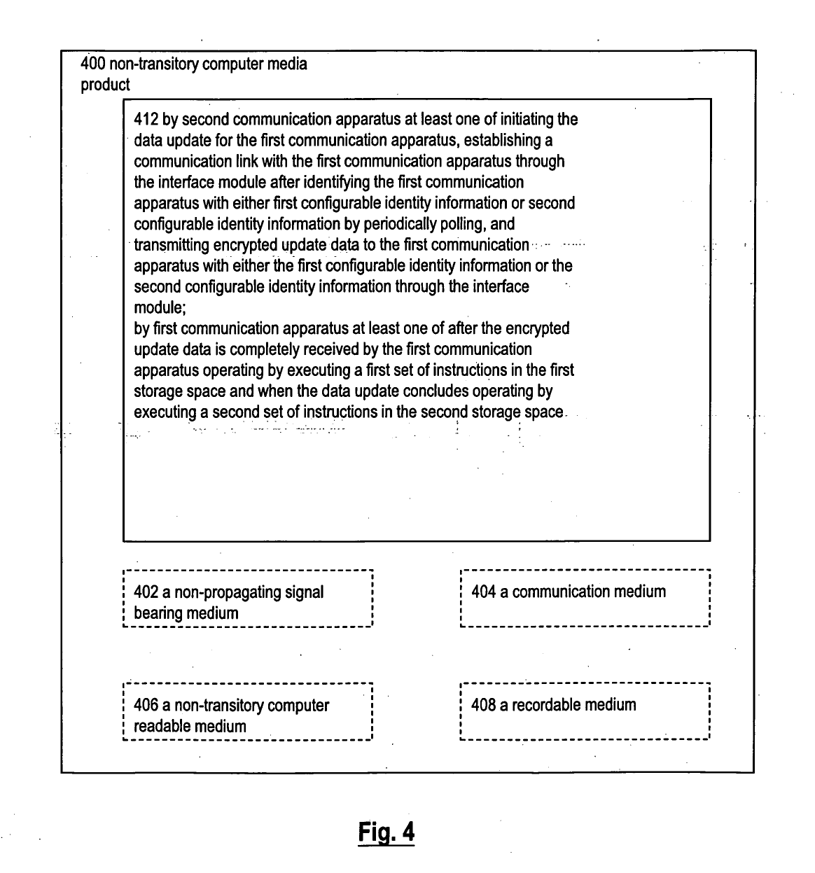

FIG. 4 is a schematic diagram illustrating a non-transitory computer readable media product 400, according to one embodiment of the present disclosure. The non-transitory computer readable media product 400 may comprise all computer-readable media, with the sole exception being a transitory, propagating signal. For example, the computer readable media product 400 may include a non-propagating signal bearing medium 402, a communication medium 404, a non-transitory computer readable medium 406, and a recordable medium 408. The computer readable media product 400 may also include computer instructions 412 when executed by the processing unit causing the processing unit to perform the method for facilitating the wireless data update.

Some modifications of these examples, as well as other possibility will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A system capable of wirelessly facilitating data update, comprising:
a first communication apparatus defining a first storage space and a second storage space; and
a second communication apparatus having a control module and an interface module;
wherein the control module is configured configured to: initiate the data update for the first communication apparatus, establish a communication link with the first communication apparatus through the interface module after identifying the first communication apparatus with either first configurable identity information or second configurable identity information by periodically polling, and transmit encrypted update data to the first communication apparatus with either the first configurable identity information or the second configurable identity information through the interface module;
wherein after the encrypted update data is completely received by the first communication apparatus the first communication apparatus is configuredconfigured to operate by executing a first set of instructions in the first storage space and when the data update concludes the first communication apparatus is configuredconfigured to operate by executing a second set of instructions in the second storage space.

2. The system according to claim 1, wherein the first communication apparatus with the first configurable identity information is the first communication apparatus that has been paired with the second communication apparatus most recently.

3. The system according to claim 1, wherein when identifying the first communication apparatus with either the first configurable identity information or the second configurable identity information the control module the control module is configured to periodically broadcast the first configurable identity information and the second configurable identity information and await corresponding responses from the first communication apparatus.

4. The system according to claim 1, wherein the first communication apparatus comprises a first buffer and a second buffer for receiving the encrypted update data and wherein when either the first buffer or the second buffer is full the first communication apparatus is configured to deliver the received encrypted update data to a data flash.

5. The system according to claim 4, wherein the first communication device is configured to authenticate a personal identity code of the decrypted data.

6. The system according to claim 1, wherein once after the communication link between the first communication apparatus and the second communication apparatus is established, the second communication apparatus is configured to authenticate a personal identification code of the first communication apparatus.

7. The system according to claim 6, wherein when the personal identification code of the first communication device is authenticated the encrypted update data is transmitted to the first communication apparatus with the authenticated personal identification code.

8. A data update method for a wirelessly updatable communication apparatus, comprising:
responding to a periodic polling request specifying either first configurable identity information or second configurable identity information when associated with either the first configurable information or the second configurable information;
receiving encrypted update data at a first buffer or a second buffer and when either the first buffer or the second buffer is full delivering the encrypted update data to a data flash for decryption;
operating by executing a first set of instructions in a first storage space after suspend operating by executing a second set of instructions in a second storage space when completely receiving the encrypted update data; and
resuming operating by executing the second set of the instructions in the second storage space, when data update using the decrypted update data concludes.

9. The method according to claim 8, further comprising authenticating personal identity code of the decrypted data before proceeding using the decrypted update data.

10. The method according to claim 8, further comprising allowing for personal identity code of the wirelessly updatable communication apparatus to be authenticated before receiving the encrypted update data.

11. The method according to claim 8, further comprising allowing for a communication link with a source of the encrypted update data to be established after the first configurable identity information or the second configurable identity information is matched.

12. The method according to claim 8, further comprising verifying the received encrypted update data and acknowledging the receipt of the encrypted update data to the source of the encrypted update data.

13. A non-transitory computer readable medium comprising a set of computer instructions capable of facilitating a wireless data update when executed by a processing unit of a first communication apparatus having a first storage space and a second storage space causing the processing unit of the first communication apparatus to:
(a) receive encrypted update data and decrypt the received encrypted update data;
(b) operating by executing a first set of instructions in the first storage space and suspend operating by executing a second set of instructions in the second storage space; and
(c) resume operating by executing the second set of the instructions in the second storage space when the data update using the decrypted update data concludes.

14. The non-transitory computer readable medium according to claim 13, further comprising the computer instructions when executed by the processing unit of the first communication apparatus causing the processing unit of the first communication apparatus to respond to a periodic polling specifying either first configurable identity information or second configurable identity information when associated with either the first configurable identity information or the second configurable identity information.

15. The non-transitory computer readable medium according to claim 14, further comprising the computer instructions when executed by the processing unit of the first communication apparatus causing the processing unit of the first communication apparatus to respond to the periodic polling with the first configurable identity information when the first communication apparatus is most recently paired with a source of the update data.

16. The non-transitory computer readable medium according to claim 13, further comprising the computer instructions when executed by the processing units of the first communication apparatus causing the processing unit of the first communication apparatus to receive the encrypted update data at a first buffer or a second buffer and when either the first buffer or the second buffer is full deliver the encrypted update data to a data flash for decryption.

17. The non-transitory computer readable medium according to claim 13, further comprising the computer instructions when executed by the processing units of the first communication apparatus causing the processing unit of the first communication apparatus to verify the received encrypted update data and acknowledge the receipt of the encrypted update data.

18. The non-transitory computer readable medium according to claim 13, further comprising the computer instructions when executed by the processing units of the first communication apparatus causing the processing unit of the first communication apparatus to allow for a personal identification code of the encrypted update data to be authenticated.

19. A non-transitory computer readable medium comprising a set of computer instructions when executed by a processing unit of a source communication apparatus having a control module and an interface module causing the processing unit of the source communication apparatus to:
(a) initiate data update for a target communication apparatus by the control module;
(b) establish a communication link with the target communication apparatus through the interface module after identifying the target communication apparatus with either first configurable identity information or second configurable identity information by periodically polling by the interface module; and
(c) transmit encrypted update data to the target communication apparatus with either the first configurable identity information or the second configurable identity information through the interface module.

20. The non-transitory computer readable medium according to claim 19, further comprising the computer instructions when executed by the processing unit of the source communication apparatus causing the processing unit of the source communication apparatus to authenticate a personal identification code of the target communication apparatus before transmitting the encrypted update data to the target communication apparatus.
